(19) United States
(12) Patent Application Publication
(10) Pub. No.: US 2025/0385296 A1
(43) Pub. Date: Dec. 18, 2025

(54) BATTERY MODULE

(71) Applicants: HYUNDAI MOTOR COMPANY, Seoul (KR); KIA CORPORATION, Seoul (KR)

(72) Inventors: Gyung Hoon Shin, Hwaseong-si (KR); Hae Woong Jung, Hwaseong-si (KR)

(73) Assignees: HYUNDAI MOTOR COMPANY, Seoul (KR); KIA CORPORATION, Seoul (KR)

(21) Appl. No.: 19/187,184

(22) Filed: Apr. 23, 2025

(30) Foreign Application Priority Data
Jun. 12, 2024 (KR) 10-2024-0076566
Feb. 11, 2025 (KR) 10-2025-0017450

(51) Int. Cl. H01M 10/04; H01M 50/211; H01M 50/262

(52) U.S. Cl. CPC H01M 10/0481; H01M 50/211; H01M 50/262

(57) ABSTRACT

Disclosed is a battery module. The battery module includes a battery stack including a plurality of battery cells stacked in a first direction, and one or more pad members provided between the plurality of battery cells, and side plates provided at two opposite sides of the battery stack in the first direction, in which an extension space is formed in the side plate and extends in one direction.

### CROSS-REFERENCE TO RELATED APPLICATIONS

This application claims priority to and the benefit of Korean Patent Application No. 10-2024-0076566 filed in the Korean Intellectual Property Office on Jun. 12, 2024, Korean Patent Application No. 10-2025-0017450 filed in the Korean Intellectual Property Office on Feb. 11, 2025, the entire contents of which are incorporated herein by reference.

### TECHNICAL FIELD

The present disclosure relates to a battery module, and further relates to a battery module including a pouch-type battery cell.

### BACKGROUND

In order to satisfy the marketability of battery modules mounted in electric vehicles, battery modules should charge sufficiently with electrical energy in a short (e.g., reduced) amount of time. Further, it is useful for the battery to have a temperature within an appropriate range during an operating process of the battery module.

Predetermined surface pressure may be applied to battery cells in the battery module in order to normally operate the battery module. To this end, the battery module may have a side plate configured to press the battery cells.

However, an overall weight of the side plate may be increased so that the side plate has rigidity to apply uniform surface pressure to entire regions of the battery cells. a battery configuration that has side plates that are rigid and apply uniform surface pressure with a reduced overall weight of the battery module.

### SUMMARY

The present disclosure provides a battery module and a side plate, which are capable of reducing a weight while having rigidity capable of applying uniform surface pressure to a battery cell.

In order to achieve the above-mentioned object, one aspect of the present disclosure provides a battery module including a battery stack including a plurality of battery cells stacked in a first direction D1, one or more pad members provided between the plurality of battery cells, and side plates provided at two opposite sides of the battery stack in the first direction D1, in which an extension space S is formed in the side plate and extends in one direction.

The extension space S may extend in a longitudinal direction as a second direction D2 intersecting the first direction D1.

The plurality of battery cells may have lead regions provided at one side of the plurality of battery cells in the second direction D2 and protruding in the second direction D2.

The extension space S may extend to two opposite ends of the side plate in the second direction D2.

The side plate may include a central plate region provided to face the battery stack in the first direction D1, and peripheral plate regions connected to two opposite ends of the central plate region in the second direction D2. The peripheral plate region may have a processed section having a smaller thickness in the first direction D1 than the other regions adjacent to the processed section.

The processed section may have a shape made by cutting an outer surface of the side plate.

The extension space S in the processed section may be opened to the outside in the first direction D1.

The processed section may be spaced apart from the central plate region in the second direction D2.

The extension space S may be provided as a plurality of extension spaces S spaced apart from one another in a third direction D3 intersecting the first and second directions D1 and D2.

The side plate may include a rib section configured to separate the two extension spaces S adjacent to each other in the third direction D3, and partition wall sections connected to two opposite ends of the rib section in the first direction D1 and extending in the third direction D3.

The rib section may be provided to have a thickness in the third direction D3 that increases as the distance from a central region of the side plate in the third direction D3 decreases.

A thickness in the first direction D1 of a portion of the partition wall section connected to the rib section may be larger than a thickness in the first direction D1 of another portion of the partition wall section.

A thickness in the third direction D3 of a portion of the rib section connected to the partition wall section may be larger than a thickness in the third direction D3 of another portion of the rib section.

The extension space S may extend in a longitudinal direction having a predetermined angle with respect to i) the first direction D1, ii) a second direction D2 perpendicularly intersecting the first direction D1, and iii) a third direction D3 perpendicularly intersecting the first and second directions D1 and D2.

The peripheral plate region may have a recessed section having a shape further recessed inward in the first direction D1 than the other regions adjacent to the recessed section.

The recessed section may be provided to be spaced apart from the processed section in a third direction D3 intersecting the first and second directions D1 and D2.

A section between the processed section and the recessed section in the third direction D3 in the peripheral plate region may be (e.g., integrally) connected to the central plate region.

The battery module may further include an end cap member provided at one side of the battery stack in the second direction D2 and fixedly coupled to the side plate, and a penetration member configured to penetrate the side plate and the end cap member, in which the penetration member penetrates the recessed section.

The battery module may further include a strip member having one side coupled to the side plate provided at one of the two opposite sides of the battery stack, and the other side coupled to the side plate provided at the other of the two opposite sides of the battery stack, in which the side plate and the strip member contain an aluminum material.

The end cap member may contain an aluminum material.

According to the present disclosure, it is possible to provide the battery module and the side plate, which are capable of reducing the weight while having rigidity capable of applying the uniform surface pressure to the battery cell.

### BRIEF DESCRIPTION OF THE DRAWINGS

FIG. 1 is a perspective view of a battery module according to the present disclosure.

FIG. 2 is an exploded perspective view illustrating components provided at one side of a battery stack in a second direction in the battery module according to the present disclosure.

FIG. 3 is an enlarged view illustrating a coupling structure between a holder member, a busbar, and a lead region of the battery module according to the present disclosure.

FIG. 4 is a view illustrating a coupling structure between the holder member and the busbar of the battery module according to the present disclosure.

FIG. 5 is an enlarged view illustrating a partial region in FIG. 4.

FIG. 6 is an enlarged view illustrating a state in which a first conductive sheet is (e.g., tightly) attached to the busbar and the lead region of the battery module according to the present disclosure.

FIG. 7 is an enlarged view illustrating a state in which the first conductive sheet is (e.g., tightly) attached to an end cap member of the battery module according to the present disclosure.

FIG. 8 is a cross-sectional view illustrating a coupling structure between the components provided at one side of the battery stack in the second direction and peripheral regions thereof in the battery module according to the present disclosure.

FIG. 9 is a cross-sectional view illustrating another example of the coupling structure between the busbar and the lead region of the battery module according to the present disclosure.

FIG. 10 is a perspective view illustrating another example of the coupling structure between the busbar and the lead region of the battery module according to the present disclosure.

FIG. 11 is a perspective view of a side plate provided in the battery module according to the present disclosure.

FIG. 12 is a first cross-sectional view illustrating a state in which the battery module according to the present disclosure is cut in a direction perpendicular to a third direction.

FIG. 13 is a second cross-sectional view illustrating a state in which the battery module according to the present disclosure is cut in the direction perpendicular to the third direction.

FIG. 14 is an enlarged cross-sectional view illustrating a state in which the side plate and the surrounding components thereof in the battery module according to the present disclosure are cut in a direction perpendicular to a second direction.

FIGS. 15A, 15B, and 15C are views illustrating various examples of a shape of a rib section of the side plate and a shape of a region in which the rib section and a partition wall section are connected.

### DETAILED DESCRIPTION

Hereinafter, a battery module according to the present disclosure is described with reference to the drawings.

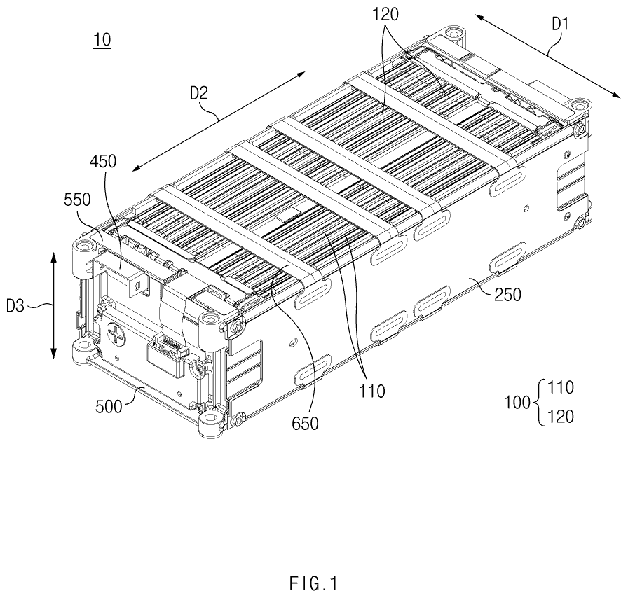

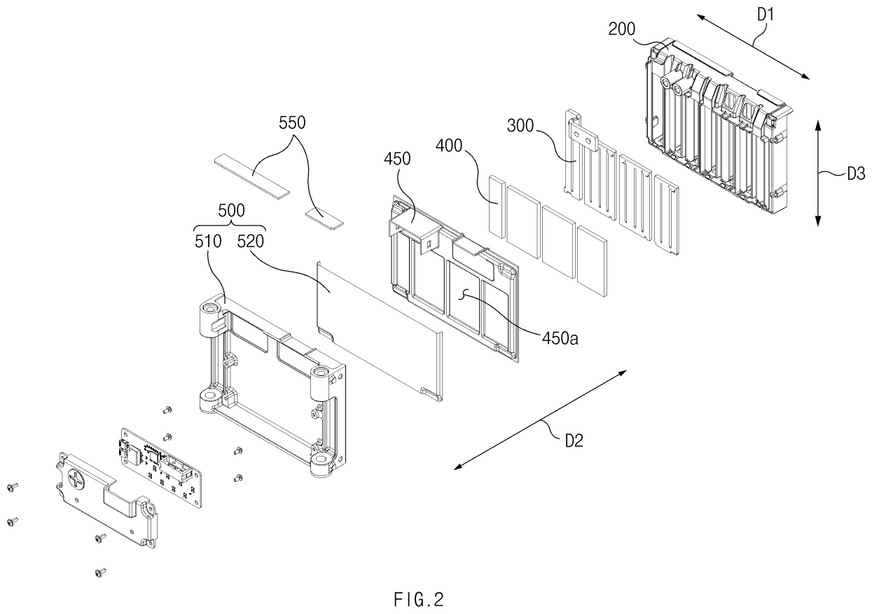

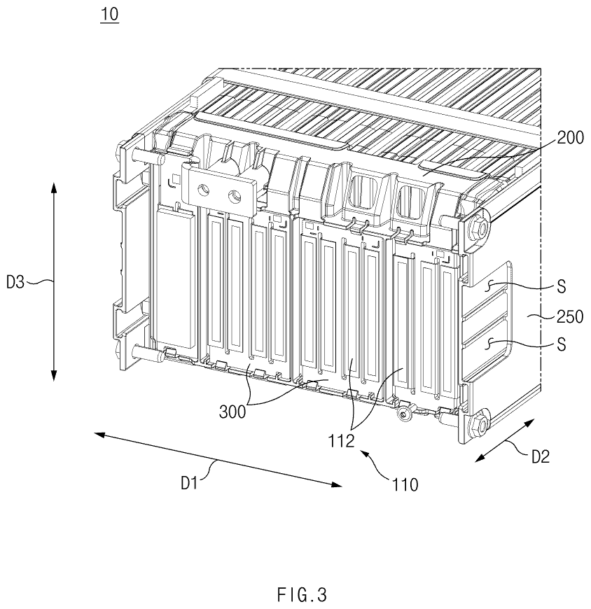

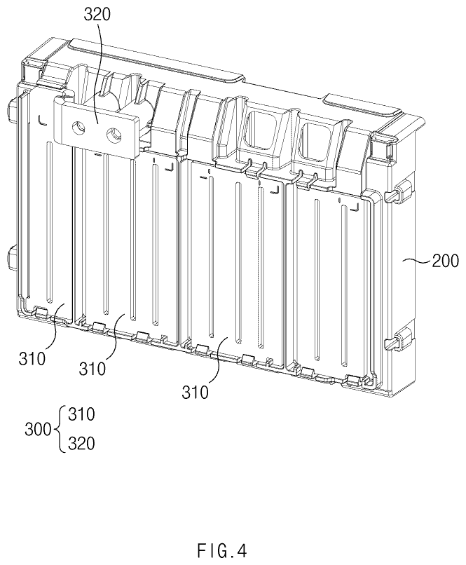

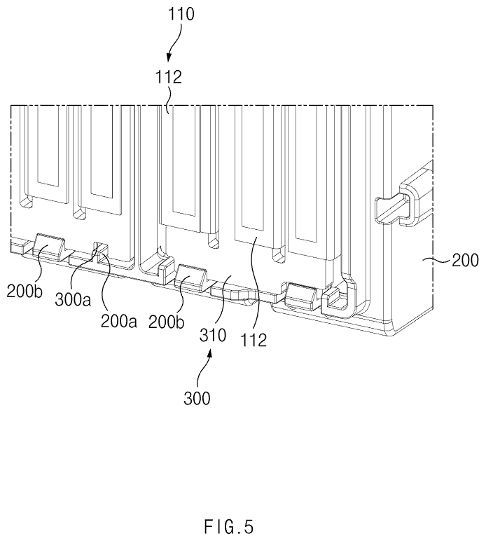

FIG. 1 is a perspective view of a battery module according to the present disclosure, and FIG. 2 is an exploded perspective view illustrating components provided at one side of a battery stack in a second direction in the battery module according to the present disclosure. FIG. 3 is an enlarged view illustrating a coupling structure between a holder member, a busbar, and a lead region of the battery module according to the present disclosure, and FIG. 4 is a view illustrating a coupling structure between the holder member and the busbar of the battery module according to the present disclosure. FIG. 5 is an enlarged view illustrating a partial region in FIG. 4.

With reference to the drawings, a battery module 10 according to the present disclosure may include a battery stack 100 including a plurality of battery cells 110 stacked in a first direction D1, and one or more pad members 120 provided between the plurality of battery cells 110. For example, the battery cell 110 may be a pouch-type secondary battery. In addition, for example, the battery stack 100 may have a structure in which the two battery cells 110 and one pad member 120 are alternately stacked. The pad member 120 may be configured to press the battery cells 110 so that predetermined surface pressure is applied to the battery cells 110 in the battery stack 100.

In addition, the battery module 10 may further include a holder member 200 provided at one side of the battery stack 100 in a second direction D2 intersecting the first direction D1, and busbars 300 assembled to the holder member 200 and electrically connected to the battery stack 100. The second direction D2 may perpendicularly intersect the first direction D1. The busbar 300 may be configured to mediate the electrical connection between the battery module 10 and external components.

The plurality of battery cells 110 may have lead regions 112 protruding outward, (e.g., tightly) attached to the busbars 300, and electrically connected to the busbars 300. For example, as illustrated in FIG. 5, the lead region 112 may include a first section configured to penetrate the busbar 300 and protrude in the second direction D2, and a second section bent in the first direction D1 from the first section and (e.g., tightly) attached to an outer surface of the busbar 300 in the second direction D2. For example, the battery cell 110 may extend in the second direction D2 (e.g., as the longitudinal direction), and the lead region 112 may be provided at an end of each of the plurality of battery cells 110 in the second direction D2.

For example, the busbar 300 and the lead region 116 may be coupled (e.g., fixed) to each other by welding. As described above, the battery cell 110 may be a pouch-type secondary battery. In this case, the battery cell 110 may further include a terrace region 114. The terrace region 114 may be configured by joining exterior materials (e.g., exterior materials of the pouch-type secondary battery). The lead region 112 may protrude outward through (e.g., from) the terrace region 114.

According to the present disclosure, when the lead region 112 is viewed from a location spaced apart from the lead region 112 in the second direction D2, there may be overlap regions 116 in which at least some of the lead regions 112 of the plurality of battery cells 110 are provided to overlap one another. The overlap region 116 may be (e.g., tightly) attached to the busbar 300. For example, the overlap region 116 may be welded to the busbar 300. Therefore, in the regions in which the overlap regions 116 are fixed to the busbars 300, some of the plurality of lead regions 112 (which provide (e.g., define) the overlap regions 116) may be (e.g., tightly) attached (e.g., directly) to the busbars 300, and some of the other lead regions 112 (which define the overlap regions 116) may be provided to face the busbars 300 with the lead regions 112, which are (e.g., tightly) attached (e.g., directly) to the busbars 300, interposed therebetween. For example, the overlap region 116 may be formed (e.g., only) at one position at one side of the battery module 10 in the second direction D2. Because one of the two lead regions 112 (which define the overlap region 116) is provided to face the busbar 300 with the other lead region 112 interposed therebetween, one lead region 112 may not be considered as being (e.g., tightly) attached to the busbar 300. However, in the present specification, both of the two lead regions 112 (which define the overlap region 116) are considered as being (e.g., tightly) attached to the busbar 300.

As described above, according to the present disclosure, some of the plurality of lead regions 112 may be electrically connected to the busbars 300 through the overlap regions 116, such that the busbar 300 may have a flat shape (e.g., as a whole) without having a bent shape. That is, a width of the battery stack 100 in the first direction D1 and a width of the busbar 300 in the first direction D1 may correspond to each other. In this case, according to the present disclosure, some of the lead regions 112 of the battery cells 110, which constitute the battery stack 100, provide (e.g., define) the overlap regions 116 and then are connected to the busbars 300. Therefore, the electrical connection between the lead regions 112 and the busbars 300 may be implemented without bending two opposite ends of the busbar 300 in the second direction D2 and then (e.g., tightly) attaching the lead regions 112 of the battery cells 110, which are disposed at two opposite ends in the second direction D2, to the two opposite bent ends of the busbar 300.

According to the present disclosure, some of the other lead regions 112 of the plurality of battery cells 110, which may not include the components for defining the overlap regions 116, may be (e.g., tightly) attached to the busbars 300 while being spaced apart from the other lead regions 112 in the first direction D1.

In addition, with reference to FIGS. 3 to 5, the holder member 200 of the battery module 10 according to the present disclosure may have a holder concave-convex portion 200a provided in a peripheral region of the holder member 200 and having a shape protruding toward the busbar 300 or a shape recessed away from the busbar 300. FIGS. 3 to 5 illustrate states (e.g., positions) in which the holder concave-convex portion 200a protrudes toward the busbar 300.

In addition, in order to correspond to the shape of the holder concave-convex portion 200a, the busbar 300 may have a busbar concave-convex portion 300a formed at a position corresponding to the holder concave-convex portion 200a, and the busbar concave-convex portion 300a may have a shape corresponding to the holder concave-convex portion 200a. The configuration in which the busbar concave-convex portion 300a has the shape corresponding to the holder concave-convex portion 200a may be provided as i) a configuration in which the busbar concave-convex portion 300a has a recessed shape when the holder concave-convex portion 200a has a protruding shape and ii) a configuration in which the busbar concave-convex portion 300a has a protruding shape when the holder concave-convex portion 200a has a recessed shape. The holder concave-convex portion 200a and the busbar concave-convex portion 300a may be configured to dispose the busbar 300 at an (e.g., exact) position during a process of assembling the busbar 300 to the holder member 200.

In addition, the holder member 200 may have a holder clip portion 200b provided in a peripheral region of the holder member 200 and having a shape protruding toward the busbar 300. The holder clip portion 200b may be configured to prevent the busbar 300 from being withdrawn from the holder member 200 after the busbar 300 is assembled to the holder member 200. In order to achieve the above-mentioned object, when the holder clip portion 200b and the surrounding components thereof are viewed from a location spaced apart from the holder clip portion 200b and the surrounding components thereof in the second direction D2, a partial region of the busbar 300 may be provided to overlap the holder clip portion 200b. Therefore, according to the present disclosure, when the busbar 300 is about to move outward from the holder member 200 in the second direction D2, the state in which the busbar 300 is assembled to the holder member 200 may be maintained by interference between the busbar 300 and the holder clip portion 200b. For example, the holder clip portion 200b may have a clip or hook shape, which may be deformed when an external force is applied inward in the second direction D2, so that the busbar 300 may push the holder clip portion 200b and be seated on the holder member 200 during the process of assembling the busbar 300 to the holder member 200.

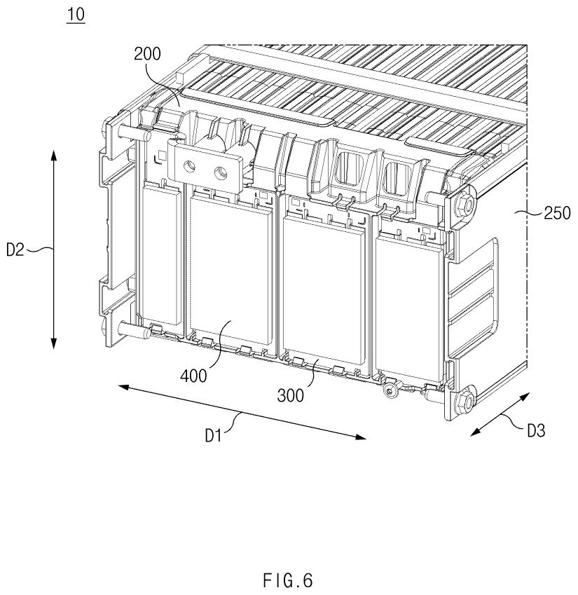

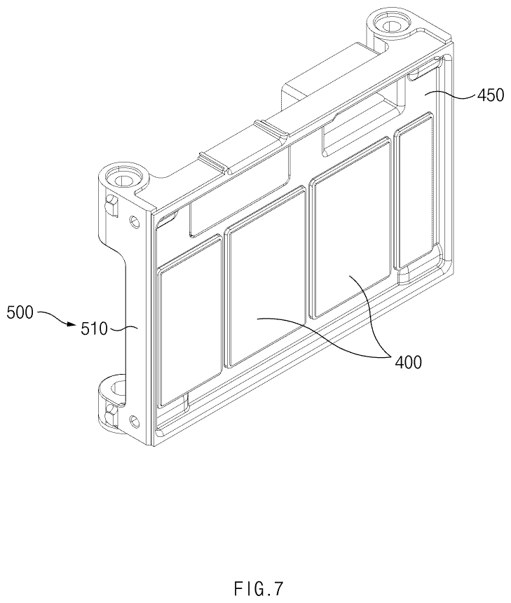

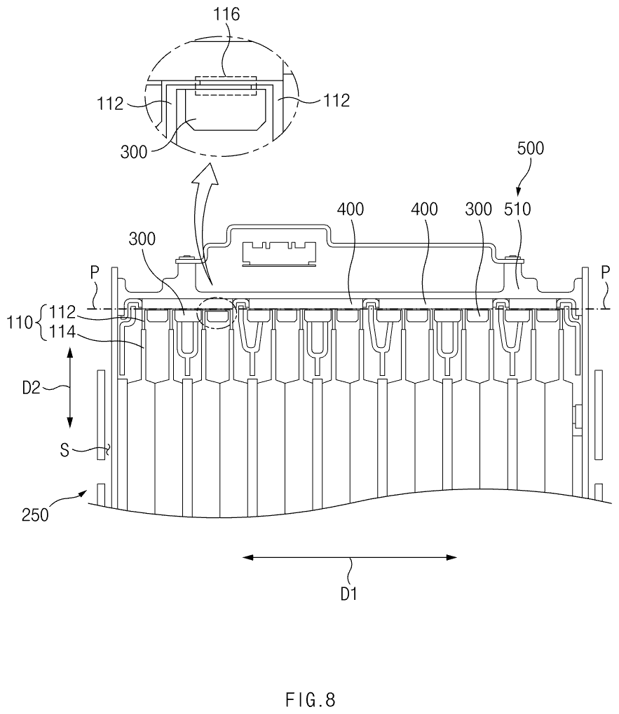

FIG. 6 is an enlarged view illustrating a state in which a first conductive sheet is (e.g., tightly) attached to the busbar and the lead region of the battery module according to the present disclosure, and FIG. 7 is an enlarged view illustrating a state in which the first conductive sheet is (e.g., tightly) attached to an end cap member of the battery module according to the present disclosure. FIG. 8 is a cross-sectional view illustrating a coupling structure between the components provided at one side of the battery stack in the second direction and peripheral regions thereof in the battery module according to the present disclosure.

According to the present disclosure, the busbar 300 may have a flat shape (e.g., as a whole). As illustrated in FIG. 8, according to the embodiment of the present disclosure, the regions of the busbars 300 to which the lead regions 112 are (e.g., tightly) attached may be provided on an (e.g., one) imaginary plane P formed in a direction perpendicularly intersecting the second direction D2. For example, the (e.g., entire) outer surface of the busbar 300 in the second direction D2 may be provided on an (e.g., one) imaginary plane P formed in the direction perpendicularly intersecting the second direction D2.

With reference to FIGS. 6 to 8, the battery module according to the present disclosure may further include first conductive sheets 400 provided to face the busbars 300 with the lead regions 112 interposed therebetween. The first conductive sheet 400 may be (e.g., tightly) attached to the lead region 112 or the busbar 300. The first conductive sheet 400 may be configured (e.g., to serve) to receive thermal energy from the busbar 300 or the lead region 112 and discharge the thermal energy to the outside. Therefore, the first conductive sheet 400 may contain or be provided as (e.g., made of) a thermally conductive material. As illustrated in FIG. 8, the first conductive sheet 400 may be provided to cover and be (e.g., tightly) attached to the (e.g., entire) region in which the lead region 112 is (e.g., tightly) attached to the busbar 300.

With reference to FIG. 4, the busbar 300 may be divided into a plurality of regions. For example, the busbar 300 may further include busbar body regions 310 configured to provide (e.g., define) an outer surface in the second direction D2, and a busbar connection region 320 provided to be spaced apart from the busbar body regions 310 in the second direction D2. The above-mentioned descriptions related to the outer surface of the busbar 300 in the second direction D2 may be the description of the outer surface of the busbar body region 310 in the second direction D2. For example, the busbar connection region 320 may extend in parallel with the outer surface of the busbar body region 310 in the second direction D2. This configuration may be understood as a configuration in which a thickness direction of the busbar connection region 320 and a thickness direction of the busbar body region 310 are parallel to each other, wherein a direction of the busbar 300 having a smallest width is provided (e.g., defined) as the thickness direction. FIG. 4 illustrates a state in which the thickness direction of the busbar body region 310 and the thickness direction of the busbar connection region 320 are parallel to the second direction D2.

The busbar connection region 320 may be configured to be coupled to another battery module other than the battery module 10. For example, a through-hole may be formed through the busbar connection region 320 in the thickness direction of the busbar connection region. When a coupling member, such as a bolt member, is fastened to the above-mentioned through-hole, the battery module 10 may be coupled to another battery module. In addition, for example, the busbar connection region 320 may be provided to be spaced apart from the busbar body region 310 in a third direction D3 intersecting the first and second directions D1 and D2. In this case, the third direction D3 may perpendicularly intersect the first direction D1 and the second direction D2.

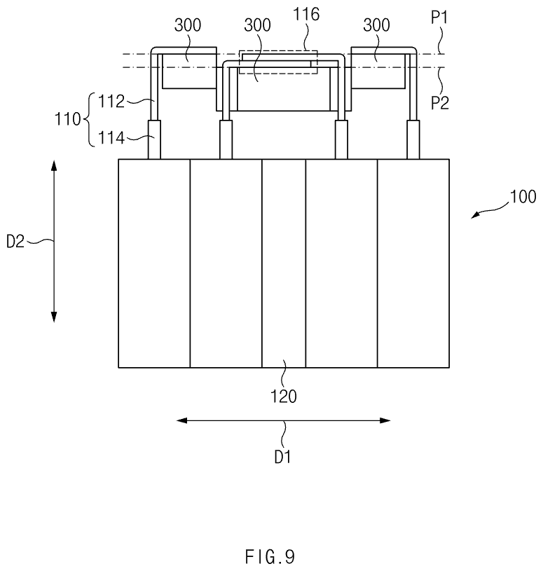

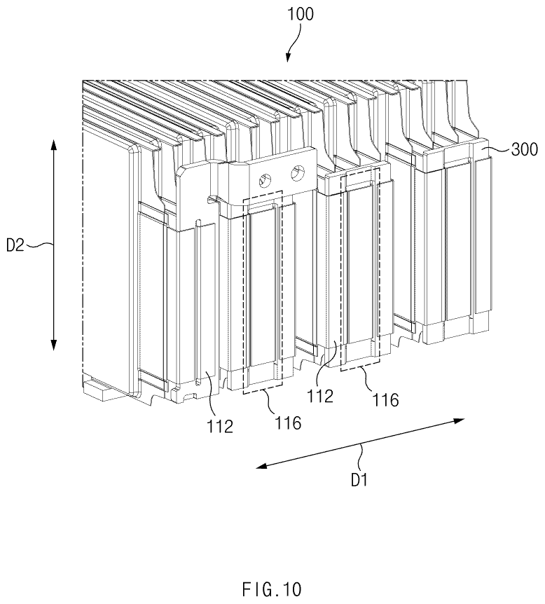

FIG. 9 is a cross-sectional view illustrating another example of the coupling structure between the busbar and the lead region of the battery module according to the present disclosure, and FIG. 10 is a perspective view illustrating another example of the coupling structure between the busbar and the lead region of the battery module according to the present disclosure.

According to another example of the present disclosure, the regions of the busbars 300 to which the lead regions 112 are (e.g., tightly) attached may be provided on a plurality of imaginary planes instead of a single imaginary plane. For example, as illustrated in FIGS. 9 and 10, according to another example of the present disclosure, some of the regions of the busbars 300 to which the lead regions 112 are (e.g., tightly) attached may be provided on a first imaginary plane P1 formed in a direction perpendicularly intersecting the second direction D2, and some of the other regions of the busbars 300 to which the lead regions 112 are (e.g., tightly) attached may be provided on a second imaginary plane P2 spaced apart from the first imaginary plane P1 in the second direction D2. For example, the second imaginary plane P2 may be provided inward of the first imaginary plane P1 in the second direction D2. The above-mentioned overlap region 116 may be (e.g., tightly) attached to the region of the busbar 300 provided on the second imaginary plane P2. That is, as illustrated in FIGS. 9 and 10, according to another example of the present disclosure, at least a partial region of the outer surface of the busbar 300 in the second direction D2 may have a shape recessed inward in the second direction D2.

According to another embodiment of the present disclosure illustrated in FIGS. 9 and 10, the stability in joining the overlap region 116 and the busbar 300 may be further improved. That is, as described above, the overlap region 116 is a region in which the two lead regions 112 overlap each other. The lead region 112 provided in the overlap region 116 may have the second section that is bent in the first direction D1 and has a (e.g., relatively long) length so that an area of the region, in which the overlap region 116 and the busbar 300 are (e.g., tightly) attached to each other, is substantially similar or identical to an area of the region in which the other electrode lead in the overlap region 116 and the busbar 300 are (e.g., tightly) attached to each other. To this end, according to another example of the present disclosure, a part of the outer surface of the busbar 300 in the second direction D2 may have a shape recessed inward in the second direction D2. In a further example of the present disclosure, the first conductive sheet 400 may be provided to cover and be (e.g., tightly) attached to the (e.g., entire) region in which the lead region 112 is (e.g., tightly) attached to the busbar 300. In this case, the section of the first conductive sheet 400, which is (e.g., tightly) attached to the overlap region 116, may have a shape recessed inward in the second direction D2.

Referring back to FIGS. 1 and 2, the battery module 10 according to the present disclosure may further include an end cap spacing member 450 provided outward of the busbar 300 in the second direction D2 and having through-holes 450a configured to accommodate the first conductive sheets 400, and an end cap member 500 provided to face the busbars 300 with the end cap spacing member 450 and the first conductive sheets 400 interposed therebetween. The end cap member 500 may be (e.g., tightly) attached to the first conductive sheets 400. Therefore, according to the present disclosure, the thermal energy transferred from the busbar 300 and the lead region 112 to the first conductive sheet 400 may be transferred back to the end cap member 500.

The end cap member 500 may be divided into a plurality of regions. For example, the end cap member 500 may include a cap body 510 configured to provide a body of the end cap member 500 and containing an electrically conductive material, and an insulation sheet 520 provided between the cap body 510 and the first conductive sheet 400, (e.g., tightly) attached to the first conductive sheet 400, the cap body 510, and the end cap spacing member 450, and containing an electrically non-conductive material.

In addition, as illustrated in FIGS. 1 and 2, the battery module 10 according to the present disclosure may further include second conductive sheets 550 (e.g., tightly) attached to one side surface of the cap body 510 and containing a thermally conductive material. The second conductive sheet 550 may be configured to receive thermal energy transferred to the end cap member 500 and discharge the thermal energy to the outside. For example, the second conductive sheet 550 may be (e.g., tightly) attached to one side surface of the cap body 510 in the third direction D3.

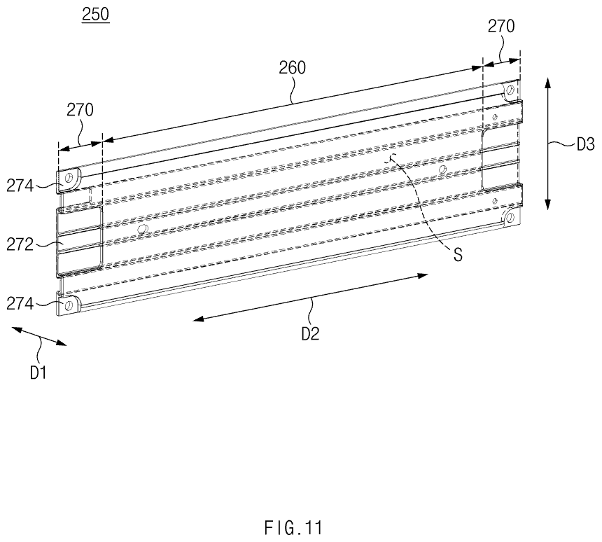

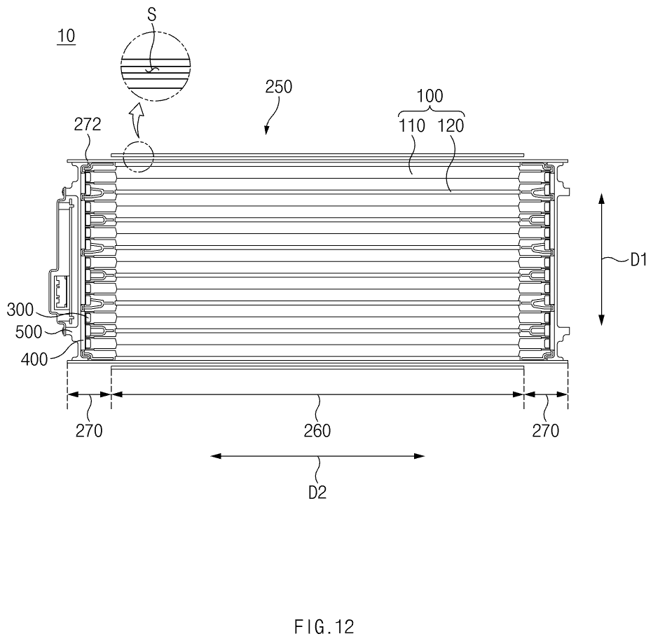

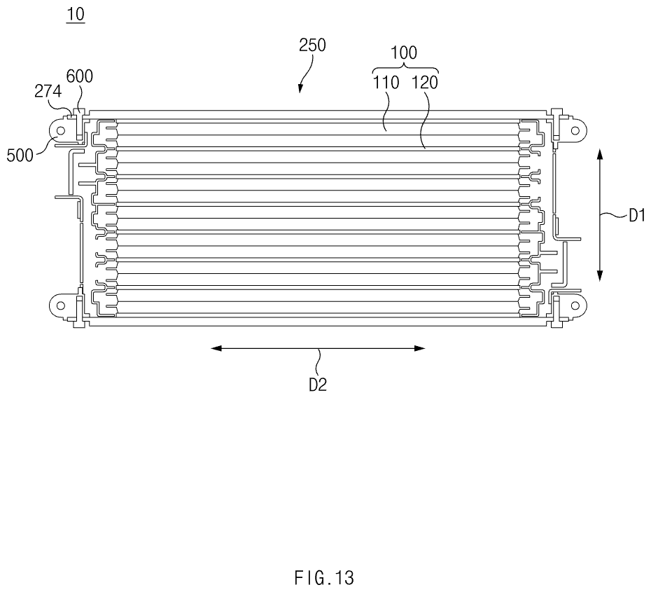

FIG. 11 is a perspective view of a side plate provided in the battery module according to the present disclosure. FIG. 12 is a first cross-sectional view illustrating a state in which the battery module according to the present disclosure is cut in a direction perpendicular to the third direction, and FIG. 13 is a second cross-sectional view illustrating a state in which the battery module according to the present disclosure is cut in the direction perpendicular to the third direction.

With reference to FIGS. 1 and 11, the battery module 10 according to the present disclosure may further include side plates 250 (e.g., a first side plate and a second side plate) respectively provided at two opposite sides (e.g., a first side and a second side) of the battery stack 100 in the first direction D1. The side plates 250 may be configured to apply predetermined surface pressure to the battery cells 110 by pressing the battery stack 100 inward in the first direction D1.

For example, the side plate 250 according to the present disclosure may have a structure provided to implement a weight reduction, increase physical rigidity, and minimize a difference in displacement amount in the first direction D1 between a central region of the side plate 250 in the second direction D2 and a peripheral region of the side plate 250 in the second direction D2.

To achieve the above-mentioned object, according to the present disclosure, extension spaces S may be formed in the side plate 250 and extend in one direction. For example, the plurality of battery cells 110 in the battery stack 100 may each have the lead region 112 provided at one side of each of the plurality of battery cells in the second direction D2 and protruding in the second direction D2, and the extension space S may extend in the second direction D2 as a longitudinal direction.

In the case that the battery cell extends in the second direction D2 as the longitudinal direction, the battery cell is longest in the second direction D2. Therefore, during the operating process of the battery module, the volume of the battery stack may vary (e.g., relatively significantly) depending on the regions in the second direction D2. That is, the volume of the battery stack may be (e.g., greatly) changed in the central region in the second direction D2, whereas the volume of the battery stack may have less change (e.g., relatively slightly changed) in the peripheral region in the second direction D2. This may cause surface pressure to be applied to the battery stack is non-uniform manner from region to region.

The side plate 250 according to the present disclosure may be configured to apply uniform pressure from region to region. According to the present disclosure, the side plate 250 is manufactured so that the extension space S extends in the second direction D2, which may provide surface pressure in a uniform manner from region to region in the longitudinal direction (i.e., the second direction) of the battery stack 100. An additional feature of the side plate 250, described below, may further contribute to providing uniform surface pressure.

The side plate 250 including the extension space S may be manufactured in various ways. For example, the side plate 250 may be manufactured by extrusion. In a case that the side plate 250 is manufactured by extrusion, the side plate 250 may be manufactured so that the extension spaces S and the regions surrounding the extension spaces S may have (e.g., substantially) constant cross-sectional shapes. In a case that the side plate 250 is manufactured by extrusion, the above-mentioned extension spaces S may extend to two opposite ends of the side plate 250 in the second direction D2 because of the nature of the extrusion. This configuration may be a configuration in which the extension spaces S communicate with the outside through the two opposite ends of the side plate 250 in the second direction D2.

The side plate 250 may be divided into a plurality of regions. For example, with reference to FIGS. 1, 11, 12, the side plate 250 may include a central plate region 260 provided to face the battery stack 100 in the first direction D1, and peripheral plate regions 270 connected to two opposite ends of the central plate region 260 in the second direction D2. That is, as described below, the central plate region 260 of the side plate 250 may be a region configured to apply surface pressure to the battery cells 110 by (e.g., directly) pressing the battery stack 100, and the peripheral plate regions 270 of the side plate 250 may be regions coupled to the end cap member 500.

In this case, according to the present disclosure, the peripheral plate region 270 may have processed sections 272. Each processed section 272 may have a smaller thickness in the first direction D1 than the (e.g., other) regions adjacent to the processed section 272. For example, the processed section 272 may have a shape made by cutting an outer surface of the side plate 250 in the first direction D1. Therefore, in the processed section 272, the above-mentioned extension space S may be opened to the outside in the first direction D1. As described above, because the peripheral plate region 270 is not configured to (e.g., directly) press the battery stack 100, the peripheral plate region 270 may have (e.g., require) relatively lower physical rigidity than the central plate region 260. Therefore, when the processed section 272 is formed in the peripheral plate region 270, it is possible to reduce an overall weight of the side plate 250 while providing (e.g., ensuring) the physical rigidity (e.g., required) for the side plate 250 to press the battery stack 100. Because the central plate region 260 is the region configured to (e.g., directly) press the battery stack 100, the processed section 272 may not be formed in the central plate region 260. For example, the processed section 272 may be spaced apart from the central plate region 260 in the second direction D2.

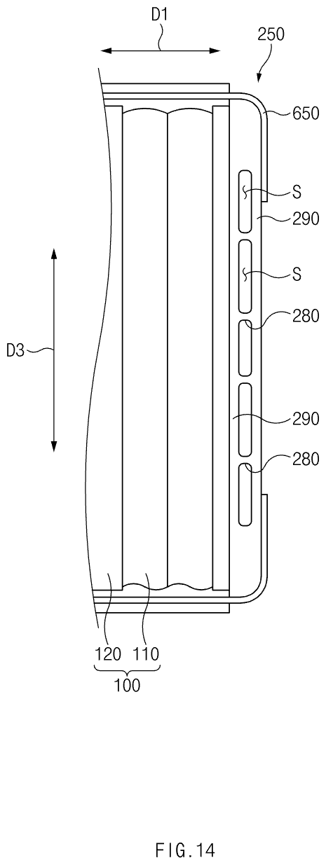

FIG. 14 is an enlarged cross-sectional view illustrating a state in which the side plate and the surrounding components thereof in the battery module according to the present disclosure are cut in a direction perpendicular to the second direction.

With reference to FIG. 14, according to the present disclosure, the extension spaces S formed in the side plate 250 may be provided as a plurality of extension spaces S spaced apart from one another in the third direction D3 intersecting the first and second direction D1 and D2. In FIG. 14, the plurality of extension spaces S may be spaced apart from one another in an upward/downward direction.

In addition, the side plate 250 may include a plurality of rib sections 280 configured to separate the two extension spaces S adjacent to each other in the third direction D3, and the side plate 250 further may include partition wall sections 290 connected to (e.g., two) opposite ends of the rib sections 280 in the first direction D1 and extending in the third direction D3. For example, the plurality of rib sections 280 may have the same thickness in the third direction D3. However, as another example, at least some of the plurality of rib sections 280 may have different thicknesses in the third direction D3. For example, the rib section 280 may have a thickness in the third direction D3 that increases as the distance from the central region of the side plate 250 in the third direction D3 decreases.

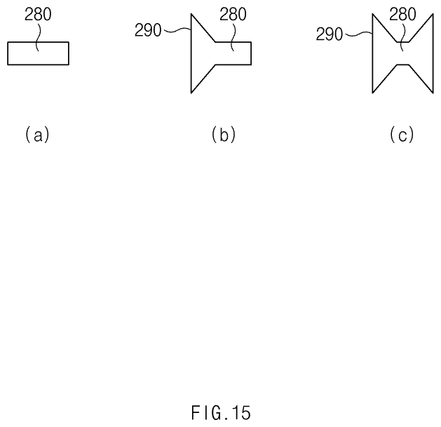

FIGS. 15A, 15B, and 15C are views illustrating various examples of a shape of a rib section of the side plate and a shape of a region in which the rib section and a partition wall section are connected.

With reference to FIGS. 14 and 15A, the thickness of the rib section 280 in the third direction D3 may be constant. However, the thickness of the rib section 280 in the third direction D3 may vary from region to region. For example, with reference to FIGS. 14, 15B, and 15C, the thickness in the third direction D3 of the portion of the rib section 280 connected to the partition wall section 290 may be larger than the thickness in the third direction D3 of (e.g., each of) the other portions of the rib section 280. From the point of view of the partition wall section 290, this configuration may be understood as a configuration in which the thickness in the first direction D1 of the portion of the partition wall section 290 connected to the rib section 280 is larger than the thickness in the first direction D1 of each of the other portions of the partition wall section 290. FIG. 15B illustrates a state in which a thickness of (e.g., only) one of the two opposite sides of the rib section 280 connected to the partition wall section 290 is (e.g., relatively) large. FIG. 15C illustrates a state in which thicknesses of the two opposite sides of the rib section 280 connected to the partition wall section 290 are (e.g., relatively) large.

FIG. 7 illustrates a state in which the extension space S is formed in the second direction D2 as the longitudinal direction and extends in the direction perpendicularly intersecting the first and third directions D1 and D3. However, unlike the configuration illustrated in FIG. 7, according to another example, the extension space S may extend in a longitudinal direction having a predetermined angle with respect to i) the first direction D1, ii) the second direction D2 perpendicularly intersecting the first direction D1, and iii) the third direction D3 perpendicularly intersecting the first and second directions D1 and D2.

Referring to FIGS. 11 and 13, the above-mentioned peripheral plate region 270 may be coupled to the end cap member 500. For example, the battery module 10 according to the present disclosure may include the end cap member 500 provided at one side of the battery stack 100 in the second direction D2 and fixedly coupled to the side plate 250, and a penetration member 600 configured to penetrate the side plate 250 and the end cap member 500. In this case, the peripheral plate region 270 may have recessed sections 274 each having a shape further recessed inward in the first direction D1 than the other regions adjacent to the recessed section 274. The penetration member 600 may penetrate the recessed section 274 and the end cap member 500. The penetration member 600 may be a screw member or a bolt member. In this case, at least a part of a head region of the penetration member 600 may be accommodated in a space provided (e.g., defined) by the recessed section 274. FIG. 11 illustrates a state in which the recessed section 274 is provided in the peripheral plate region 270 and spaced apart from the processed section 272 in the third direction D3 intersecting the first and second directions D1 and D2.

In addition, with reference to FIG. 11, a section between the processed section 272 and the recessed section 274 in the third direction D3 in the peripheral plate region 270 may be (e.g., integrally) connected to the central plate region 260. This configuration may be understood as a configuration in which the central plate region 260 and the section between the processed section 272 and the recessed section 274 in the third direction D3 in the peripheral plate region 270 have shapes considered as being (e.g., substantially) similar or identical to each other.

With reference back to FIG. 1, the battery module 10 according to the present disclosure may further include strip members 650 each having one side coupled to the side plate 250 provided at one of the two opposite sides of the battery stack 100 in the first direction D1, and the other side coupled to the side plate 250 provided at the other of the two opposite sides of the battery stack 100 in the first direction D1. The strip member 650 may be configured to apply surface pressure to the battery stack 100 together with the side plate 250.

The strip member 650 and the side plate 250 may contain or be made of the same metallic material. The strip member 650 and the side plate 250 may be coupled to each other by welding. In a case that the strip member 500 and the side plate 250 contain the same metallic material, the welding may be smoothly performed. For example, the strip member 650 and the side plate 250 may contain or be made of aluminum metal. The cap body 510 of the end cap member 500 may also contain or be made of aluminum metal.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A battery module comprising:
a battery stack comprising a plurality of battery cells stacked in a first direction, and at least one pad member provided between the plurality of battery cells; and
a first side plate provided on a first side of the battery stack and a second side plate provided on a second side of the battery stack, wherein the second side is opposite of the first side, and wherein the first side and the second side are provided in the first direction, and
wherein an extension space is formed in at least one of the first side plate or the second side plate, and wherein the extension space extends in a second direction.

2. The battery module of claim 1, wherein the extension space extends in a longitudinal direction as the second direction and wherein the second direction intersects the first direction.

3. The battery module of claim 2, wherein the plurality of battery cells include lead regions provided at a side of the plurality of battery cells in the second direction and protrude in the second direction.

4. The battery module of claim 2, wherein the extension space extends to two opposite ends of at least one of the first side plate or the second side plate in the second direction.

5. The battery module of claim 2, wherein at least one of the first side plate or the second side plate includes:
a central plate region provided to face the battery stack in the first direction; and
a plurality of peripheral plate regions connected to two opposite ends of the central plate region in the second direction and
wherein at least one of the plurality of peripheral plate regions has a processed section having a smaller thickness in the first direction than other regions adjacent to the processed section.

6. The battery module of claim 5, wherein the processed section includes a shape formed by cutting an outer surface of at least one of the first side plate or the second side plate.

7. The battery module of claim 6, wherein the extension space is provided in the processed section and is open to the outside in the first direction.

8. The battery module of claim 5, wherein the processed section is spaced apart from the central plate region in the second direction.

9. The battery module of claim 2, wherein the extension space is provided as a plurality of extension spaces spaced apart from one another in a third direction, wherein the third direction intersects the first and second directions.

10. The battery module of claim 9, wherein the at least one of the first side plate or the second side plate comprises:
a rib section configured to separate two extension spaces of the plurality of extension spaces, wherein the two extensions spaces are adjacent in the third direction; and
a partition wall section connected to two opposite ends of the rib section in the first direction and extending in the third direction.

11. The battery module of claim 10, wherein the rib section has a thickness in the third direction that increases as a distance from a central region of at least one of the first side plate or the second side plate decreases in the third direction.

12. The battery module of claim 10, wherein a thickness in the first direction of a portion of the partition wall section connected to the rib section is larger than a thickness in the first direction of another portion of the partition wall section.

13. The battery module of claim 10, wherein a thickness in the third direction of a portion of the rib section connected to the partition wall section is larger than a thickness in the third direction of another portion of the rib section.

14. The battery module of claim 1, wherein the extension space extends in a longitudinal direction having a predetermined angle with respect to at least one of i) the first direction, ii) a second direction perpendicularly intersecting the first direction, and iii) a third direction perpendicularly intersecting the first and second directions and.

15. The battery module of claim 5, wherein at least one of the plurality of plate regions has a recessed section having a shape further recessed inward in the first direction than the other regions adjacent to the recessed section.

16. The battery module of claim 15, wherein the recessed section is provided to be spaced apart from the processed section in a third direction, wherein the third direction intersects the first direction and the second direction.

17. The battery module of claim 16, wherein a section between the processed section and the recessed section in the third direction in the peripheral plate region is integrally connected to the central plate region.

18. The battery module of claim 15, further comprising:
an end cap member coupled to the battery stack in the second direction and fixedly coupled to at least one of the first side plate or the second side plate; and
a penetration member configured to penetrate the end cap member and at least one of the first side plate or the second side plate,
wherein the penetration member penetrates the recessed section.

19. The battery module of claim 18, further comprising:
a strip member having a side coupled to at least one of the first side plate or the second side plate,
wherein the strip member contain an aluminum material.

20. The battery module of claim 19, wherein the end cap member contains an aluminum material.
